(19) United States
(12) Patent Application Publication
(10) Pub. No.: US 2007/0079811 A1
(43) Pub. Date: Apr. 12, 2007

(54) Fuel injection controller of diesel engine

(75) Inventor: Noriaki Nakane, Komaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/542,239

(22) Filed: Oct. 4, 2006

(30) Foreign Application Priority Data
Oct. 6, 2005 (JP) 2005-293147

(51) Int. Cl. F02M 51/00; F02B 3/00

(52) U.S. Cl. 123/478; 123/299

(57) ABSTRACT

A fuel injection controller of a diesel engine calculates a requirement injection amount based on an operation amount of an accelerator pedal and rotation speed of the engine. The fuel injection controller divides the requirement injection amount into multiple injections. Injection amounts of the divided injections are set to monotonically increase with respect to an order of the injections. Thus, even if a simple fuel injection device is used, the fuel injection controller can suitably achieve both of reduction of a discharge amount of nitrogen oxides and reduction of fuel consumption.

### CROSS REFERENCE TO RELATED APPLICATION

This application is based on and incorporates herein by reference Japanese Patent Application No. 2005-293147 filed on Oct. 6, 2005.

### BACKGROUND OF THE INVENTION

1. Field of the Invention

The present invention relates to a fuel injection controller that performs fuel injection control by operating a fuel injection device of a diesel engine having a pressure accumulation chamber for accumulating fuel in a high-pressure state, a fuel pump for pressure-feeding the fuel to the pressure accumulation chamber and a fuel injection valve for injecting the fuel accumulated in the pressure accumulation chamber.

2. Description of Related Art

A known fuel injection device of this kind has a common pressure accumulation chamber (common rail) for supplying high-pressure fuel to fuel injection valves of respective cylinders of a diesel engine as described in JP-A-S62-258160, for example. The common rail diesel engine can freely control fuel pressure in the common rail in accordance with an engine operation state, so the engine can freely control the fuel pressure supplied to the fuel injection valves.

Normally, in the diesel engine, in order to generate requirement torque corresponding to an operation amount of an accelerator pedal provided by a user, a required fuel amount (requirement injection amount) is calculated based on the operation amount of the accelerator pedal and rotation speed. A command injection period of the fuel injection valve is set to inject the requirement injection amount of the fuel.

In the case where the requirement injection amount of the fuel is injected in one fuel injection, the fuel combusts at once, so an amount of nitrogen oxides (NOx) discharged from the diesel engine tends to increase. Therefore, conventionally, a minute fuel injection before a main injection is proposed, e.g., as described in JP-A-H10-504622. The main injection is an injection of the requirement injection amount for generating the torque required in accordance with the operation amount of the accelerator pedal provided by the user. By performing the minute fuel injection before the main injection, the combustion as of the main injection is alleviated and the discharge amount of the NOx is reduced.

In the case where the multiple step injections are performed like this, the fuel injection amount necessary for generating the required torque of the diesel engine tends to increase, so a fuel consumption tends to increase.

It is assumed that a boot-shaped injection for changing a fuel injection rate from a small value to a large value in one injection is ideal for reducing the fuel consumption while reducing the discharge amount of the NOx. In order to perform the fuel injection in such a manner, a system or the like capable of variably setting the fuel pressure supplied to the fuel injection valve in one injection period is required. Accordingly, it is difficult to perform the boot-shaped injection with a simple fuel injection device.

### SUMMARY OF THE INVENTION

It is an object of the present invention to provide a fuel injection controller of a diesel engine capable of suitably achieving both of reduction of a discharge amount of nitrogen oxides and reduction of fuel consumption even in the case where a simple fuel injection device is used.

According to an aspect of the present invention, a fuel injection controller has a taking device, a calculating device and a setting device. The taking device takes in a sensing result of a sensor for sensing a load of the engine and rotation speed of an output shaft of the engine. The calculating device calculates a required injection amount based on the load and the rotation speed. The setting device divides the required injection amount into multiple injection amounts with a dividing number such that the injection amounts are monotonically nondecreasing with respect to an order of the injections of the fuel and for setting intervals among the injections within intervals providing continuous heat generation through the injections. The dividing number includes three or a greater number.

With this structure, the requirement injection amount is divided and injected. Accordingly, the combustion of the fuel is alleviated and the discharge amount of the NOx can be reduced. By setting the intervals among the injections within the intervals providing the continuous heat generation of the injections, the required torque can be generated efficiently. Since the injection amounts are monotonically nondecreasing, the torque can be generated more efficiently. Thus, the requirement fuel amount for generating the required torque can be reduced, so the fuel consumption can be reduced. Accordingly, with the above-described structure, reduction of the discharge amount of the NOx and reduction of the fuel consumption can be suitably achieved at the same time even in the case where a simple fuel injection device is used.

### BRIEF DESCRIPTION OF THE DRAWINGS

Features and advantages of an embodiment will be appreciated, as well as methods of operation and the function of the related parts, from a study of the following detailed description, the appended claims, and the drawings, all of which form a part of this application. In the drawings:

FIG. 1 is a diagram showing an engine system according to a first example embodiment of the present invention;

FIG. 2 is a map used to calculate a command injection period from fuel pressure and an injection amount;

FIG. 3A is a diagram showing a fuel injection rate waveform;

FIG. 3B is a diagram showing another fuel injection rate waveform;

FIG. 3C is a diagram showing a heat generation rate waveform corresponding to the fuel injection rate waveform of FIG. 3A or 3B;

FIG. 4A is a diagram showing a boot-shaped injection rate waveform;

FIG. 4B is a diagram showing a heat generation rate waveform corresponding to the injection rate waveform of FIG. 4A;

FIG. 5A is a diagram showing an injection rate waveform according to the FIG. 1 embodiment;

FIG. 5B is a diagram showing a heat generation rate waveform corresponding to the injection rate waveform of FIG. 5A; and

FIG. 6 is a flowchart showing processing steps of fuel injection control according to the FIG. 1 embodiment.

### DETAILED DESCRIPTION OF EXAMPLE EMBODIMENT

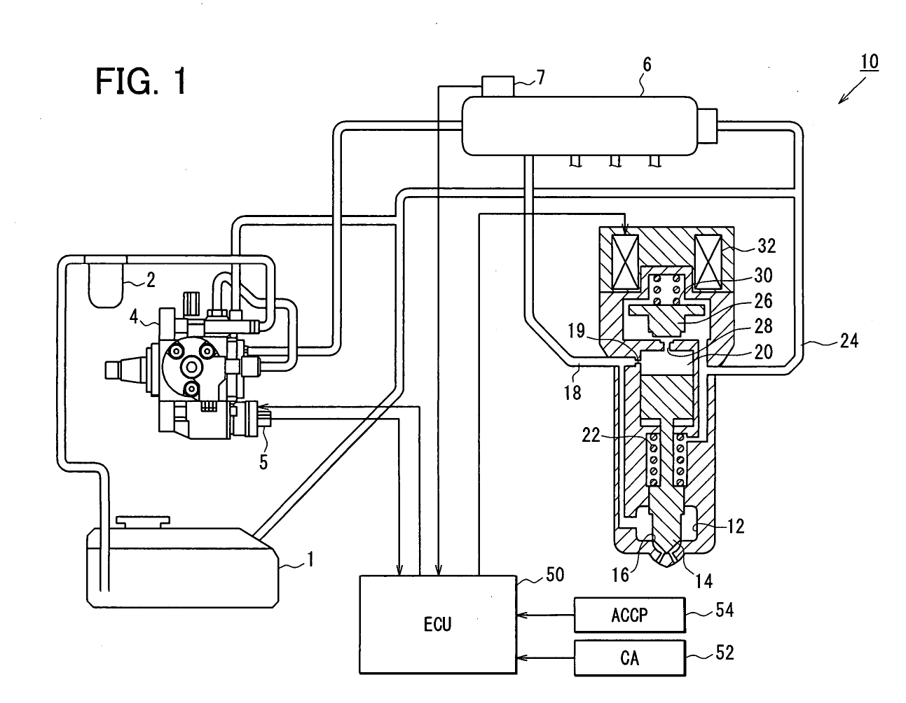

Referring to FIG. 1, an engine system according to an example embodiment of the present invention is illustrated. As shown in FIG. 1, a fuel pump 4 draws fuel from a fuel tank 1 through a filter 2. The fuel drawn by the fuel pump 4 is pressurized and supplied to a common rail 6. The common rail 6 is a pipe for accumulating high-pressure fuel pressure-fed by the fuel pump 4 and for distributing the fuel to fuel injection valves 10 of respective cylinders. The fuel pump 4 is provided with a fuel temperature sensor 5 for sensing temperature of the fuel pressure-fed to the common rail 6. The common rail 6 is provided with a fuel pressure sensor 7 for sensing fuel pressure P in the common rail 6.

The fuel injection valve 10 supplies the high-pressure fuel supplied from the common rail 6 into a combustion chamber of the diesel engine through injection. A needle accommodation section 12 in the shape of a circular column is provided at a tip end of the fuel injection valve 10. The needle accommodation section 12 accommodates a nozzle needle 14 capable of moving in an axial direction. The nozzle needle 14 is seated on an annular needle seat 16 formed in the tip end portion of the fuel injection valve 10 to block the needle accommodation section 12 from an outside (combustion chamber of engine). The nozzle needle 14 separates from the needle seat 16 to connect the needle accommodation section 12 with the outside. The needle accommodation section 12 is supplied with the high-pressure fuel from the common rail 6 through a high-pressure fuel passage 18.

A backside of the nozzle needle 14 (side opposite from the needle seat 16) faces a back pressure chamber 20. The back pressure chamber 20 is supplied with the high-pressure fuel from the common rail 6 through the high-pressure fuel passage 18 and an orifice 19. A needle spring 22 is provided in an intermediate portion of the nozzle needle 14. The needle spring 22 biases the nozzle needle 14 toward the tip end of the fuel injection valve 10.

A low-pressure fuel passage 24 communicates with the fuel tank 1. A valve member 26 provides and breaks communication between the low-pressure fuel passage 24 and the back pressure chamber 20. The valve member 26 blocks an orifice 28 connecting the back pressure chamber 20 and the low-pressure fuel passage 24 to break the communication between the back pressure chamber 20 and the low-pressure fuel passage 24. The valve member 26 opens the orifice 28 to provide the communication between the back pressure chamber 20 and the low-pressure fuel passage 24.

The valve member 26 is biased by a valve spring 30 toward the tip end of the fuel injection valve 10. The valve member 26 is attracted by an electromagnetic force of an electromagnetic solenoid 32 to move toward the backside of the fuel injection valve 10.

In this structure, the valve member 26 blocks the orifice 28 due to a force of the valve spring 30 when the electromagnetic solenoid 32 is de-energized and the attraction of the electromagnetic solenoid 32 is not exerted. The nozzle needle 14 is pushed by the needle spring 22 toward the tip end of the fuel injection valve 10 to be seated on the needle seat 16, whereby providing a valve closed state of the fuel injection valve 10.

If the electromagnetic solenoid 32 is energized, the valve member 26 moves toward the backside of the fuel injection valve 10 due to the attraction of the electromagnetic solenoid 32 to open the orifice 28. Thus, the high-pressure fuel in the back pressure chamber.20 flows out to the low-pressure fuel passage 24 through the orifice 28. Accordingly, the force applied to the nozzle needle 14 by the high-pressure fuel in the back pressure chamber 20 becomes less than the force applied to the nozzle needle 14 by the high-pressure fuel in the needle accommodation section 12. If the difference between the forces becomes greater than the force of the needle spring 22 to push the nozzle needle 14 toward the tip end of the fuel injection valve 10, the nozzle needle 14 is separated from the needle seat 16, whereby providing a valve opened state of the fuel injection valve 10.

An electronic control unit (ECU) 50 includes CPU and a memory. The ECU 50 takes in sensing values of various sensors for sensing operation states of the diesel engine or requirements of the user. The ECU 50 controls output characteristics of the diesel engine based on the sensing results. The various sensors for sensing the operation states of the diesel engine and the like include the fuel temperature sensor 5, the fuel pressure sensor 7 and a crank angle sensor 52 for sensing a rotation angle (crank angle: CA) of an output shaft of the diesel engine. The sensors for sensing the requirements of the user include an accelerator sensor 54 for sensing the operation amount ACCP of the accelerator pedal.

In order to control the output of the diesel engine, the ECU 50 performs fuel injection control for maintaining suitable output characteristics or exhaust characteristics of the diesel engine in accordance with the operation states of the diesel engine.

The ECU 50 sets target fuel pressure in the common rail 6 based on the operation states of the diesel engine. The ECU 50 operates the fuel pump 4 based on the target fuel pressure to control the actual fuel pressure P in the common rail 6 to the target fuel pressure. The ECU 50 calculates a required fuel injection amount (requirement injection amount) Q based on the requirements of the user or the operation states of the diesel engine. The ECU 50 sets a command injection period TFIN in accordance with the requirement injection amount Q and fuel pressure P sensed by the fuel pressure sensor 7, and performs energization operation of the fuel injection valve 10 based on the set command injection period TFIN.

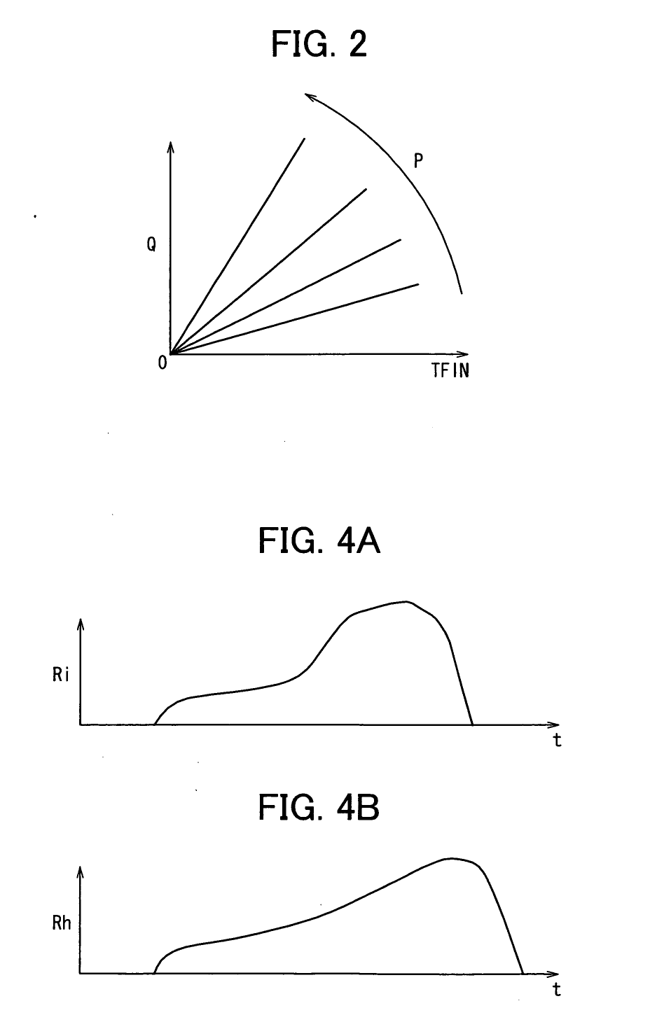

The command injection period TFIN is calculated by using a map shown in FIG. 2. The map is for determining a relationship among the requirement injection amount Q, the fuel pressure P and the command injection period TFIN. If the command injection period TFIN is constant, the actually injected injection amount increases as the fuel pressure P increases. Therefore, the command injection period TFIN is calculated from the fuel pressure P and the requirement injection amount Q.

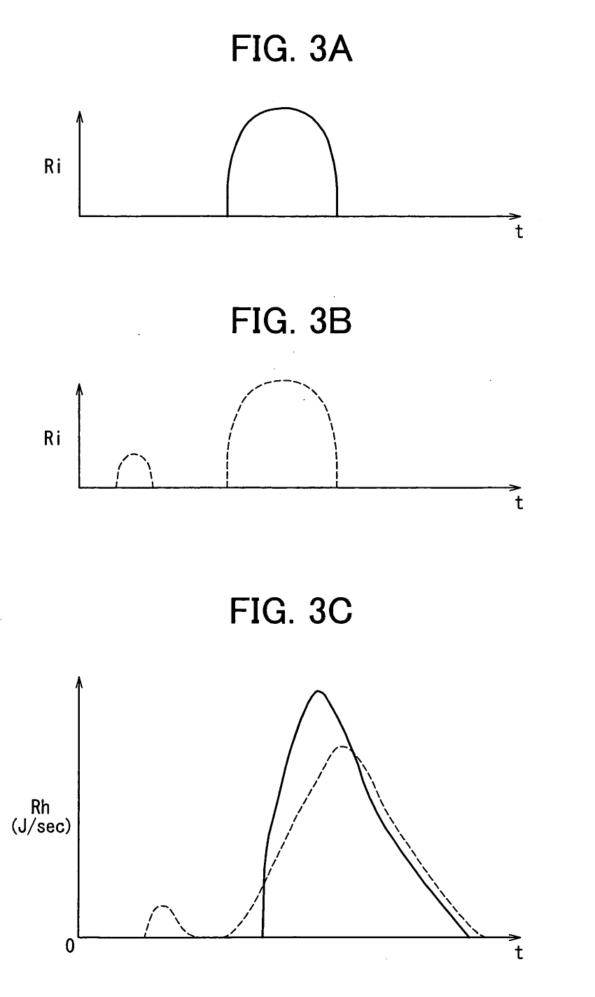

If the requirement injection amount Q of the fuel is injected at once to generate the requirement torque corresponding to the operation amount ACCP of the accelerator pedal provided by the user, the fuel combusts at once. As a result, an amount of NOx discharged from the combustion chamber of the diesel engine increases. FIG. 3A shows a waveform of an injection rate Ri in the case where the fuel of the requirement injection amount Q is injected at once. A solid line in FIG. 3C shows a heat generation rate Rh in the combustion chamber of the diesel engine at that time. The fuel injection rate Ri is defined as a fuel injection amount per unit time. The heat generation rate Rh is defined as a heat amount generated per unit time. As shown in FIG. 3C, the heat generation rate Rh drastically increases and has a high peak value. Therefore, the combustion temperature increases and a large amount of the NOx is generated.

If a minute fuel injection is performed before the fuel injection (main injection) of the requirement injection amount as shown in FIG. 3B, the fuel combustion of the main injection is alleviated. As a result, the increasing speed of the heat generation rate Rh and the peak value of the heat generation rate Rh are reduced as shown by a broken line in FIG. 3C. Accordingly, the combustion temperature decreases and the generation amount of the NOx is reduced. However, in this case, the main injection is performed after the heat generation rate Rh due to the minute fuel injection becomes zero. Accordingly, the torque due to the minute fuel injection and the torque due to the main injection are generated discontinuously. In this case, the torque generated by the minute fuel injection is small and negligible. Accordingly, the requirement torque has to be generated by the main injection. Therefore, the fuel consumption is larger in the case where the requirement torque is generated by performing the minute injection before the main injection than in the case where the requirement torque is generated by one fuel injection.

It is assumed that a boot-shaped injection for changing the fuel injection rate Ri from a small value to a large value in the shape of a boot in one fuel injection as shown in FIG. 4A is ideal for suitably achieving both of the reduction of the NOx and the reduction of the fuel injection amount. Thus, as shown in FIG. 4B, the increase of the heat generation rate Rh is alleviated and the peak value of the heat generation rate Rh is reduced. As a result, the combustion temperature can be reduced and the generation amount of the NOx can be reduced. Moreover, in this case, the heat generation rate Rh monotonically increases with time. Accordingly, the injected fuel efficiently contributes to the generation of the torque. There is a relationship that the output torque of the diesel engine increases as the temporal integration value of the heat generation rate waveform increases. The output torque is decided by the temporal integration value of the fuel injection rate waveform, i.e., fuel injection amount.

However, it is difficult to perform the boot-shaped injection with the above-described structure. It is because the fuel injection valve 10 is operated in a binary manner between the valve opened state and the valve closed state in accordance with energization or de-energization of the electromagnetic solenoid 32, for example. With this structure, the fuel injection rate Ri is uniquely decided by the fuel pressure P supplied through the high-pressure fuel passage 18 after the nozzle needle 14 separates from the needle seat 16 and reaches a predetermined lifting amount. Accordingly, the boot-shaped injection is difficult.

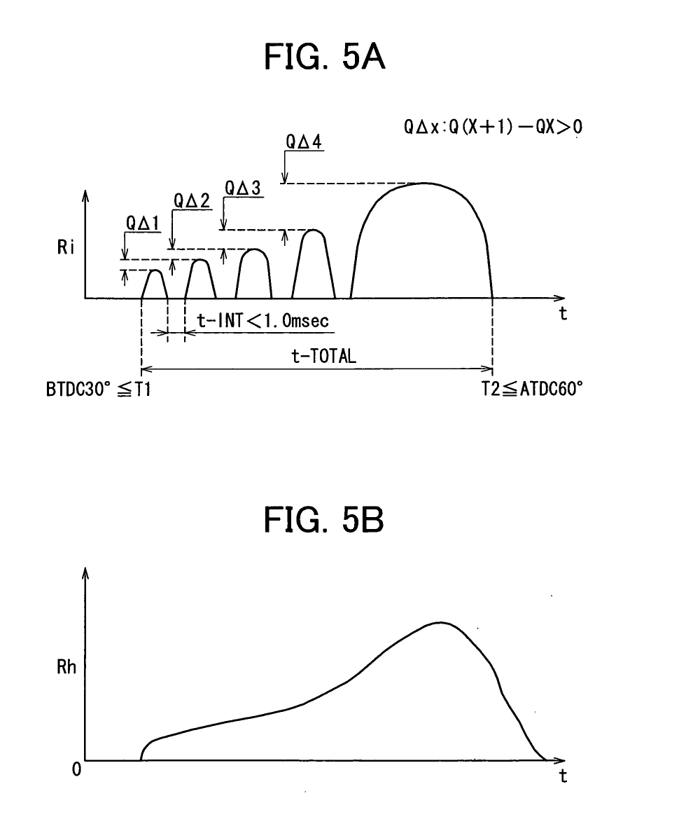

Therefore, in the present embodiment, the requirement injection amount Q is divided into multiple injection amounts such that the injection amounts are monotonically nondecreasing with respect to the order of the injections and intervals t-INT among the injections are set within intervals in which the heat generation due to the injections is continuous, e.g., as shown in FIG. 5A.

In the example shown in FIG. 5A, five-step fuel injections are performed. The intervals t-INT among the fuel injections are set within intervals in which the heat generation due to the injections is continuous. Thus, the fuel used in the combustions in the respective injections efficiently contributes to the generation of the torque. Each of intervals t-INT for achieving the continuous heat generation should be preferably set at 1.0 msec or shorter.

The injection amounts Q1-Q5 of the five injections are set to be monotonically nondecreasing. Thus, as shown in FIG. 5B, the heat generation rate waveform due to the fuel injections can be made as a substantially monotone nondecreasing waveform. As a result, a torque loss, which can be caused when the heat generation rate waveform due to the fuel injections takes the waveform of repetition of increase and decrease, can be suitably inhibited. Specifically, in the present embodiment, the injection amounts Q1-Q5 monotonically increase such that Q1<Q2, Q2<Q3, Q3<Q4 and Q4<Q5. Thus, even if the fuel pressure P in the common rail 6 fluctuates in an unexpected manner and deviates from desired fuel pressure, the possibility that the fuel amount actually injected in the later injection becomes smaller than the fuel amount actually injected in the former injection can be suitably reduced. The unexpected fluctuation tends to occur because the common rail 6 is commonly used by the multiple fuel injection valves 10.

Specifically, in the present embodiment, the injection amounts Q1-Q5 are set to satisfy following relationships (1) and (2).
(Q2−Q1)/Q2×100<50, (1)
(Q(i+1)−Q(i))/Q(i+1)×100<30:i≧2, (2)

These are settings for approximating the injection rate waveform to an ideal waveform of a boot-shaped injection or for approximating the heat generation rate waveform to a waveform accompanying the boot-shaped injection. The injection amount Q1 should be preferably set in a range from 3 to 10 mm3/st, which is a fuel amount required in the first injection for performing the combustion.

The multiple fuel injections are performed in a range from 30° CA BTDC (30° crank angle before top dead center) to 60° CAATDC (60° crank angle after top dead center). It is because there is a possibility that the injected fuel adheres to a cylinder inner wall and the like of the diesel engine and is not used in the combustion if the fuel injection is advanced or delayed excessively with respect to the top dead center (TDC). Practically, in order to efficiently make the heat generated by the injections continuous, the period (total injection period t-TOTAL from T1 to T2) for performing the multiple injections should be preferably set in an angle range within 40° CA in the above-described range.

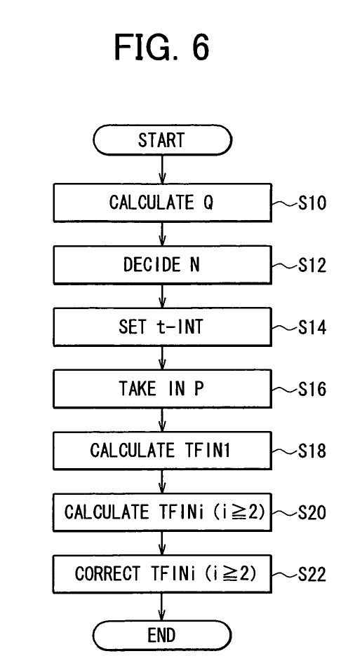

FIG. 6 shows processing steps of the fuel injection control according to the present embodiment. The ECU 50 performs the processing. In the series of the processing, Step S10 calculates the requirement injection amount Q based on the operation amount ACCP of the accelerator pedal sensed by the accelerator sensor 54 and the rotation speed sensed by the crank angle sensor 52. Then, Step S12 sets the dividing number N of the requirement injection amount Q calculated at Step S10, e.g., in a range from 2 to 5, based on the accelerator pedal operation amount ACCP and the rotation speed. The dividing number N may be increased as the requirement injection amount Q increases. Thus, the peak value of the heat generation rate Rh accompanying the injections can be reduced.

Then, Step S14 sets the intervals t-INT among the injections based on the fuel temperature sensed by the fuel temperature sensor 5 and the rotation speed. The intervals t-INT are set based on time. The setting based on the time is performed because of easy control of the intervals t-INT capable of providing the continuous heat generation through the injections, and also, because of following reasons.

First, the intervals t-INT are set based on the time to easily grasp the phase of a pressure pulsation in the common rail 6, which is caused by the former injection, as of the later injection. Secondly, the intervals t-INT are set based on the time because the shortest allowable interval is defined by the time. That is, a certain response delay is caused when the fuel injection valve 10 is opened or closed in accordance with the energization or de-energization of the electromagnetic solenoid 32. Therefore, in order to perform the fuel injection intermittently, the intervals have to be set equal to or longer than the shortest time defined by the response of the fuel injection valve 10. Normally, the shortest time is approximately 0.2 msec. If the interval t-INT between the adjacent injections is set shorter than 0.2 msec, the valve closing operation of the fuel injection valve 10 in the former injection overlaps with the valve opening operation of the fuel injection valve 10 in the latter injection. Thus, the control accuracy of the fuel injection is deteriorated.

The intervals t-INT are basically set in accordance with the dividing number N set at Step S12. More specifically, the intervals t-INT are variably set in accordance with the dividing number N, the rotation speed and the fuel temperature.

The rotation speed is a parameter correlated with the time corresponding to the crank angle range (30° CA BTDC to 60° CAATDC) in which the multiple fuel injections can be performed. As the rotation speed increases, the time necessary for the rotation of the range shortens. As the time necessary for the rotation shortens, the maximum value of the time allowed as the interval t-INT of the injections also shortens. Accordingly, the intervals t-INT are variably set in accordance with the rotation speed. For example, the intervals t-INT are shortened as the rotation speed increases.

The fuel temperature is a parameter correlated with the cycle of the pressure pulsation generated in the common rail 6. The viscosity of the fuel increases as the fuel temperature decreases. Accordingly, the cycle of the pressure pulsation changes in accordance with the change of the fuel temperature. Therefore, by variably setting the intervals t-INT in accordance with the fuel temperature, the phase is regulated. For example, the phase of the pressure pulsation, which is caused by the former injection, as of the latter injection is set constant regardless of the fuel temperature.

Then, Step S16 takes in a sensing value of the fuel pressure P sensed by the fuel pressure sensor 7. Step S18 calculates the first command injection period TFIN1 by using the map shown in FIG. 2 based on the sensing value of the fuel pressure P sensed by the fuel pressure sensor 7 and the first injection amount Q1.

Step S20 calculates the second or following command injection period TFINi (i≧2) by using the map shown in FIG. 2 based on the fuel pressure P sensed at Step S16 (fuel pressure immediately before the first injection) and the second or following injection amount Qi (i≧2). Step S22 corrects the command injection period TFINi calculated at Step S20 based on the fluctuation of the fuel pressure P due to the fuel injection(s) during the period from the first fuel injection to the present fuel injection. Even in the second or following fuel injection, the command injection period TFINi is calculated based on the fuel pressure P sensed immediately before the first fuel injection. Therefore, the used fuel pressure P is not a suitable value as the fuel pressure P in the common rail 6 as of the fuel injection. Therefore, in consideration of the pressure fluctuation caused by the other fuel injection(s) during the period from the sensing timing of the fuel pressure P to the present fuel injection, the command injection period TFINi calculated at Step S20 is corrected to obtain the suitable command injection period TFINi for the fuel pressure P as of the present fuel injection. A correction value is calculated based on the phase of the pressure pulsation as of the present injection and the reduction of the fuel pressure due to the injection(s) performed before. The phase of the pressure pulsation as of the present injection is grasped based on the intervals t-INT calculated at Step S14.

The present embodiment exerts following effects.

(I) The requirement injection amount is divided into multiple injection amounts such that the injection amounts are monotonically nondecreasing with respect to the order of the fuel injections and such that the intervals among the injections are set within the intervals providing continuous heat generation through the injections. Thus, the NOx can be reduced without performing minute injection causing discontinuous heat generation. Accordingly, the reduction of the discharge amount of the NOx and the reduction of the fuel consumption can be suitably achieved at the same time.

(II) The dividing number for dividing the requirement injection amount is variably set in accordance with the operation amount of the accelerator pedal and the rotation speed. Accordingly, the fuel injections can be performed with the suitable diving number in accordance with the requirement injection amount.

(III) The intervals among the injections for injecting the divided requirement injection amount are set by the time. Thus, the intervals for providing the continuous heat generation through the injections can be set easily. Even if the pressure pulsation is caused in the fuel pressure in the pressure accumulation chamber due to the former injection, the phase of the pressure pulsation as of the latter injection can be grasped easily.

(IV) Each interval between the injections is set at 1.0 msec or shorter. Thus, the intervals providing the continuous heat generation of the injections can be provided.

(V) The injection amounts of the injections are set to monotonically increase with respect to the order of the fuel injections. Thus, even in the case where the actual injection amount deviates from the desired amount, e.g., when the pressure in the common rail 6 makes unexpected fluctuation, the possibility that the fuel amount of the latter injection is smaller than that of the former injection can be reduced sufficiently.

(VI) The injection amount Qi of each injection is set as follows: (Q2−Q1)/Q2×100<50, (Q(i+1)−Q(i))/Q(i+1)×100<30:i≧2. Thus, the fuel injection rate can be approximated to the boot shape that is ideal to suitably achieve both of the reduction of the NOx and the reduction of the fuel injection amount. As a result, the heat generation rate waveform can be approximated to the waveform generated by the boot-shaped injection.

(VII) The timing of the multiple fuel injections is set within the range from 30° CA BTDC to 60° CAATDC. Thus, the injected fuel is devoted to the combustion.

(VIII) The intervals among the injections are variably set in accordance with the rotation speed. Thus, the intervals suitable for each rotation speed can be set even if the time necessary for the rotation of the crank angle enabling the injections changes in accordance with the rotation speed.

(IX) The intervals among the injections are variably set in accordance with the fuel temperature. Thus, even if the cycle of the pressure pulsation changes in accordance with the fuel temperature, the influence of the pressure pulsation due to the former injection over the fuel pressure as of the latter injection can be regulated.

(X) The command injection period of the second or following injection out of the injections for injecting the divided requirement injection amount is calculated by using the map shown in FIG. 2, and then, the command injection period is corrected and used. Thus, the second or following command injection period can be suitably set by using the fuel pressure sensed immediately before the first injection.

The above-described embodiment may be modified as follows.

Instead of variably setting the intervals in accordance with the fuel temperature, a correction value for correcting the command injection period in accordance with the fuel temperature may be set.

If the fuel pressure can be sensed immediately before each one of the injections injecting the divided requirement injection amount, the command injection period can be calculated accurately without performing the processing of Step S22 shown in FIG. 6.

The calculation of the requirement injection amount is not limited to the calculation performed based on the operation amount of the accelerator pedal and the rotation speed. For example, the requirement injection amount may be calculated based on the requirement torque and the rotation speed.

The decision of the dividing number of the requirement injection amount is not limited to that performed based on the operation amount of the accelerator pedal and the rotation speed. For example, the dividing number of the requirement injection amount may be calculated based on the requirement torque and the rotation speed. Alternatively, the dividing number may be calculated based on the requirement injection amount.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A fuel injection controller that performs fuel injection control by operating a fuel injection device of a diesel engine having a pressure accumulation chamber for accumulating fuel in a high-pressure state, a fuel pump for pressure-feeding the fuel to the pressure accumulation chamber and a fuel injection valve for injecting the fuel accumulated in the pressure accumulation chamber, the fuel injection controller comprising:
a taking device that takes in a sensing result of a sensor for sensing a load of the engine and rotation speed of an output shaft of the engine;
a calculating device that calculates a required injection amount based on the load and the rotation speed; and
a setting device that divides the required injection amount into multiple injection amounts with a dividing number such that the injection amounts are monotonically nondecreasing with respect to an order of the injections of the fuel and for setting intervals among the injections within intervals providing continuous heat generation through the injections, wherein
the dividing number includes three or a greater number.

2. The fuel injection controller as in claim 1, wherein
the setting device variably sets the dividing number out of plural numbers based on the load and the rotation speed.

3. The fuel injection controller as in claim 1, wherein
the intervals among the injections are set based on time.

4. The fuel injection controller as in claim 1, wherein
the interval is set at 1.0 msec or shorter.

5. The fuel injection controller as in claim 1, wherein
the injection amounts of the injections are set to monotonically increase with respect to the order of the injections.

6. The fuel injection controller as in claim 1, wherein
the interval is set at 0.2 msec or longer.

7. The fuel injection controller as in claim 1, wherein
the interval is shortened as the rotation speed increases.

8. The fuel injection controller as in claim 1, wherein
the interval is variably set in accordance with temperature of the fuel.

9. The fuel injection controller as in claim 8, wherein
the intervals are set such that a latter injection out of the injections is performed at the same phase of pressure pulsation, which is generated in the pressure accumulation chamber by a former injection out of the injections, regardless of the fuel temperature.

10. The fuel injection controller as in claim 1, wherein
the setting device calculates the injection amounts of the injections to satisfy:
(Q2−Q1)/Q2×100<50; and
(Q(i+1)−Q(i))/Q(i+1)×100<30,
where Q1 is an injection amount of a first injection out of the injections, Q2 is an injection amount of a second injection out of the injections, and i is an integer equal to or greater than 2.

11. The fuel injection controller as in claim 10, wherein
the injection amount of the first injection is set in a range from 3 to 10 mm3/st.

12. The fuel injection controller as in claim 1, wherein
the setting device sets timing of the injections in a certain angle range from 30° CA before top dead center to 60° CA after top dead center.

13. The fuel injection controller as in claim 12, wherein
the injections are performed in a range of 40° CA in the certain angle range.
